(19) United States
(12) Patent Application Publication
(10) Pub. No.: US 2014/0169359 A1
(43) Pub. Date: Jun. 19, 2014

(54) OPTIMIZED TIME-SLOT STRUCTURE FOR BLOCKIZED COMMUNICATION

(71) Applicant: MOTOROLA MOBILITY LLC, Libertyville, IL (US)

(72) Inventors: Jian Wu, Reading (GB); Howard P. Benn, Swindon (GB); Walter Featherstone, Swindon (GB)

(73) Assignee: MOTOROLA MOBILITY LLC, Libertyville, IL (US)

(21) Appl. No.: 13/714,691

(22) Filed: Dec. 14, 2012

(51) Int. Cl. H04J 3/00

(52) U.S. Cl. CPC H04J 3/00
USPC 370/345

(57) ABSTRACT

Embodiments of the invention provide a system and method for generating an optimized data block to save power consumption for both base station and mobile station when one user is in silent mode in VAMOS operation, including application to machine type communication. Three different optimized time-slots are designed and in-band signaling will inform a mobile station which optimized time-slot is received.

### BACKGROUND

GSM (Global System for Mobile Communications, originally Groupe Spécial Mobile), is a standard set developed by the European Telecommunications Standards Institute (ETSI) to describe protocols for second generation (2G) digital cellular networks used by mobile phones. The GSM standard was developed as a replacement for first generation (1G) analog cellular networks, and originally described a digital, circuit switched network optimized for full duplex voice telephony. This was expanded over time to include data communications, first by circuit switched transport, then packet data transport via GPRS (General Packet Radio Services) and EDGE (Enhanced Data rates for GSM Evolution or EGPRS). GSM is a cellular network, which means that cell phones connect to it by searching for cells in the immediate vicinity.

VAMOS (Voice services over Adaptive Multi-user channels on One Slot) is a development that allows operators to double the voice capacity for GSM networks without any decrease in voice quality. VAMOS is a very cost efficient way to handle increasing traffic growth. This is particularly relevant in emerging markets, where GSM traffic is expected to grow sharply in the next few years.

### BRIEF SUMMARY OF THE DRAWINGS

The accompanying drawings, which are incorporated in and form a part of the specification, illustrate various embodiments of the invention. In the drawings:

FIG. 1 illustrates a VAMOS technology communication system;

FIG. 2 illustrates the power consumption when the base station of FIG. 1 transmits a current data block;

FIG. 3 illustrates an example optimized data block in accordance with embodiments of the invention;

FIG. 4 illustrates the power consumption when a base station transmits the optimized data block of FIG. 3;

FIG. 5A illustrates a current data block of FIG. 2 and the optimized data block of FIG. 3, in accordance with embodiments of the invention;

FIG. 5B illustrates a current data block of FIG. 2, and a right-shifted optimized data block in accordance with embodiments of the invention;

FIG. 5C illustrates a current data block of FIG. 2, and a left-shifted data block in accordance with embodiments of the invention;

FIG. 5D illustrates a current data block in FIG. 2, a right-shifted optimized data block and a left-shifted data block in accordance with embodiments of the invention;

FIG. 6 illustrates an example VAMOS technology communication system, in accordance with embodiments of the invention;

FIG. 7 illustrates an example encoder in accordance with embodiments of the invention; and

FIG. 8 illustrates an example decoder in accordance with embodiments of the invention.

### DETAILED DESCRIPTION

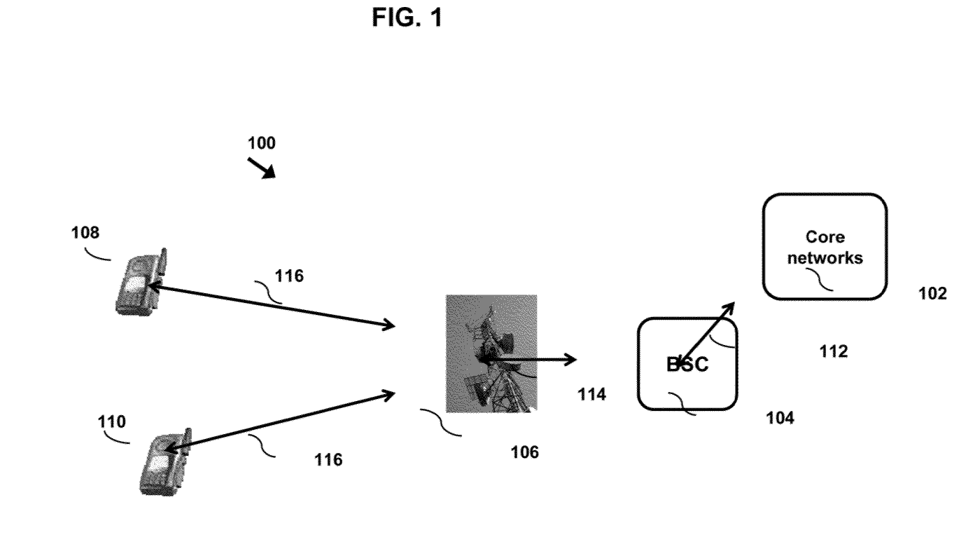

FIG. 1 illustrates a VAMOS technology communication system 100.

As shown in the figure, system 100 includes core networks 102, a base station controller (BSC) 104, a base station 106, a mobile station 108 and a mobile station 110.

Base station 106 is also arranged to receive a communication signal 114 from BSC 104. Mobile station 108 is arranged to receive a communication signal 116 from base station 106. Mobile station 110 is arranged to receive a communication signal 116 from base station 106.

In VAMOS, speech signals for two users are transmitted simultaneously in the same timeslot using the same carrier frequency. For example, BSC 104 may send a communication signal destined for mobile station 108 and a communication signal destined for mobile station 110. Base station 106 will encode the communication signals, in this example the combination of which is illustrated as a single VAMOS signal, communication signal 116.

Mobile station 108 will receive and decode communication signal 116. The decoded portion of communication signal 116 that is intended for mobile station 110 will be ignored by mobile station 108 and the portion of communication signal 116 that is intended for mobile station 108 will be processed. Similarly, mobile station 110 will receive and decode communication signal 116. The decoded portion of communication signal 116 that is intended for mobile station 108 will be ignored by mobile station 110 and the portion of communication signal 116 that is intended for mobile station 110 will be processed.

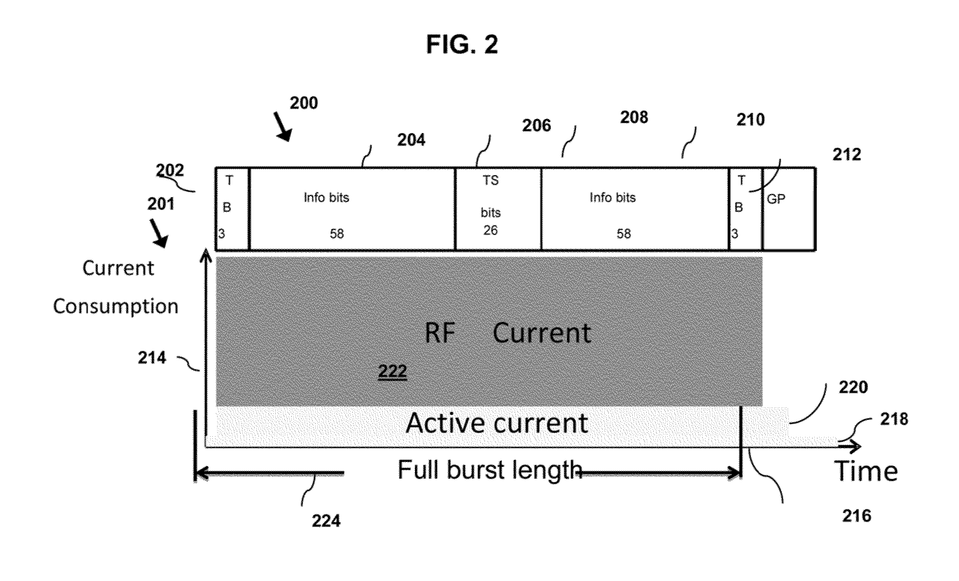

By providing a single communication for two users, the VAMOS timeslot structure increases the capacity at the base station. This will be described in more detail with reference to FIG. 2.

FIG. 2 illustrates the power consumption when base station 106 transmits a current data block for two users. FIG. 2 includes a current data block 200 and a graph 201.

Data block 200 includes a tail bits (TB) portion 202, a payload portion (information bits) 204, a training sequence (TS) portion 206, a payload portion (information bits) 208, a TB portion 210 and a guard portion (GP) 212. TB portion 202 is the start of data block 200. Payload portion 204 follows TB portion 202 and is followed by TS portion 206 and payload portion 208. GP 212 follows TB portion 210.

TB portion 202 is the start of data block 200.

Payload portion 204 and 208 includes encrypted data for two users. For purposes of discussion, the two users are mobile station 108 and mobile station 110 of FIG. 1. In an example embodiment, encrypted data for two users are modulated into AQPSK (Adaptive Quadrature Phase-Shift Keying) and one user's payload is at the most significant position and another user's payload is at the least significant position of AQPSK. Payload portion 204 and 208 will be processed by mobile station 110 to extract its intended data and the payload portion, which is intended for mobile station 108, will be discarded by mobile station 110.

TS portion 206 is used for channel estimation. As such, a correlator (not shown) in mobile stations 108 or 110 may find TS portion 206, which will then be used to find the remaining portions of data block 200.

GP 212 acts as a buffer to separate adjoining received data blocks.

Graph 201 includes a y-axis 214, an x-axis 216 a leakage current portion 218, an active current portion 220, an RF current portion 222. Y-axis 214 measures current consumption, whereas x-axis 216 measures time. A full burst length is indicated by double arrow 224.

Data block 200 is but one block of a series of blocks that make up communication signal 116, as shown in FIG. 1. When base station 106 is on, but is not transmitting signals, it is consuming a relatively low amount of power. This low amount of power is associated with leakage current portion 218.

Before base station 106 can transmit a data block, it must power up, which corresponds to the current consumption shown by active current portion 220. The current consumption corresponding to the transmission of data block 200 is RF current portion 222. Once data block 200 is transmitted, the amount of current consumption is shown in FIG. 2.

For GSM, when a user is in silent mode the system will enter Discontinuous transmission (DTX) state. In this state the base station will stop regular transmission in order to reduce the system interference and power consumption. Currently, with VAMOS two users share a timeslot and the base station will continue to transmit whole burst even when one of the users has entered into silent mode. In addition, the other mobile station will not know and will continue to receive whole timeslot and process it. For example, consider the situation where the portion of communication signal 116 that is intended for mobile station 108 is a silent period. In such a situation, mobile station 108 will still decode and process the signal—even though there is no data in the signal. This results in unnecessary power consumption in by mobile station 108.

What is needed is a system and method that reduces power consumption when a signal destined for a mobile station is in a silent period (and the corresponding user in silent mode).

Embodiments of the invention provide a system and method that reduces BTS and mobile station power consumption when a signal destined for that mobile station is in a silent period.

Further, Machine Type Communications (MTC) is expanding rapidly and has the potential to generate significant revenues for mobile network operators. MTC devices are expected to outnumber voice subscribers by at least two orders of magnitude. Some predictions are much higher. MTC allows machines to communicate directly with one another. MTC has the potential to radically change the world and the way that people interact with machines.

There are essential differences between people and machines. Machines are excellent at routine and well-defined tasks that require a constant level of attention; people get bored by repetition and stop paying attention, make mistakes, miss inputs. People are very good at tasks that require intelligence and adaptability; machines cannot cope with events outside their programming Machines can react to inputs very quickly; human responses are slower.

As technology evolves, there are important changes in capabilities and costs. More computing power, memory and communication capabilities make it possible for machines to take over tasks presently done by, but not well suited to human beings. Lower costs make it practical for machines to take over tasks not well suited to expensive human beings. Increasing capabilities and lower costs together open new opportunities for revenue generating services not previously economical to do.

The increasing capability of machines makes it possible to avoid dull and repetitious work having to be done by people, freeing them to utilize their capabilities and intelligence in better suited and much more fruitful activities.

For MTC, small data packets are expected for smart meters etc. Current VAMOS timeslot structures would use whole timeslot to transmit such small data packets. For example, returning to FIG. 2, the entire payload portion 204 and 208 may not be needed to transmit an MTC data packet. This certainly wastes expensive system capacity and reduces the spectrum efficiency. Power consumption for base stations using a power generator is a huge Operation Expense (OPEX) for operators. Further, huge power consumption at the base station is also bad for the environment.

What is additionally needed is a VAMOS timeslot structure that may be used for MTC, which reduces power consumption at the base station.

Embodiments of the invention provide a system and method for generating a VAMOS timeslot structure that may be used for MTC, which reduces power consumption at the mobile station.

Data block 200 includes TB portion 202, the first half of payload portion 204, TS portion 206, the second half of payload portion 208, TB portion 210 and guard portion 212. The payload is for two users. For purposes of discussion, the two users are mobile station 108 and mobile station 110 of FIG. 1.

Embodiments of the invention provide a system and method for generating an optimized data block having two payload sections. Both payload sections will be halved compared to current data block 200 of FIG. 2 because one user is in silent mode in VAMOS operation. In-band signaling will inform a mobile station to detect the right time slot.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

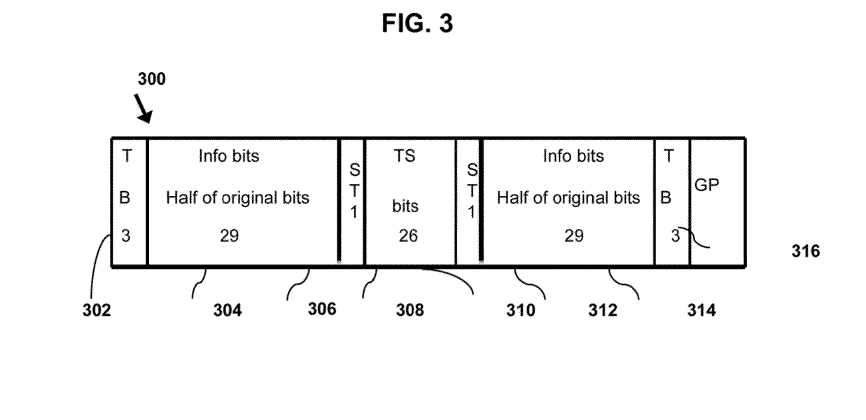

Example embodiments of the invention will now be described with reference to FIGS. 3-8.

FIG. 3 illustrates an example optimized data block 300 in accordance with embodiments of the invention.

As shown in the figure, optimized data block 300 includes a TB portion 302, a payload portion 304, a signaling time slot portion 306, a TS portion 308, a signaling time slot portion 310, a payload portion 312, a TB portion 314 and a GP 316. TB portion 302 is the start of optimized data block 300. Payload portion 304 follows TB portion 302 and is followed by signaling time slot portion 306. TS portion 308 follows signaling time slot portion 306 and is followed by signaling time slot portion 310. Payload portion 312 follows signaling time slot portion 310 and is followed by TB portion 314. GP 316 follows TB portion 314.

TB portion 302 similar to TB portion 202, in that TB portion 302 is the start of data block 300. TB portion 314 bookends the payload portion of data block 300.

Payload portion 304 and payload portion 312 together are sufficient for the mobile station that is not in DTX because payload portion 304 and payload portion 312 together are the full payload for mobile station.

TS portion 308 is similar to TS portion 206 of data block 200 and is used for channel estimation. As such, a correlator may find TS portion 308, which will then be used to find the remaining portions of data block 300.

GP 316 acts as a buffer to separate adjoining received data blocks.

Signaling time slot portion 306 and signaling time slot portion 310 indicate the state the next data block to be received. This will be described in more detail later.

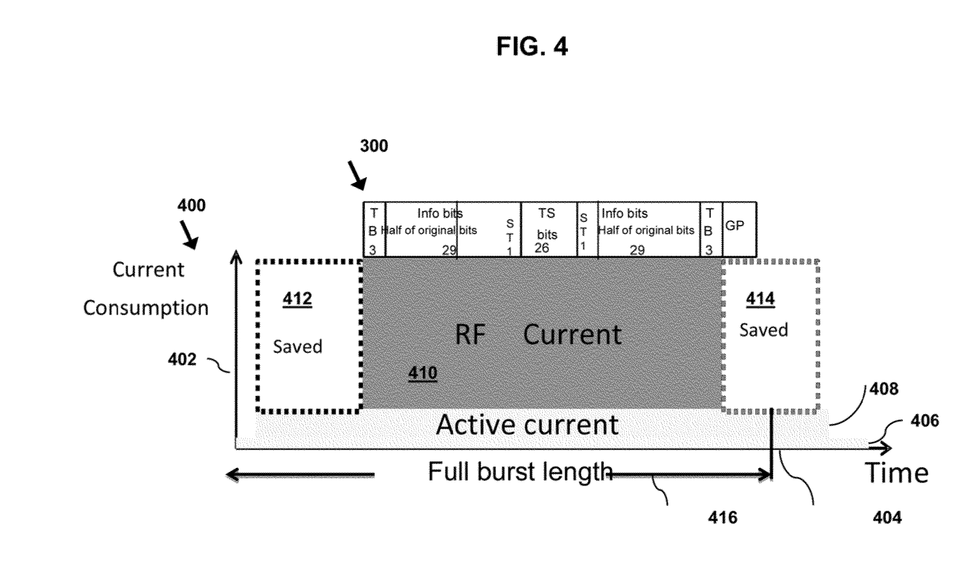

The data block structure is generated through embodiments of the invention provide enhanced power consumption savings, which will be described below with reference to FIG. 4.

FIG. 4 illustrates the power consumption when a base station transmits optimized data block 300. FIG. 4 includes data block 300 and a graph 400.

Graph 400 includes a y-axis 402, an x-axis 404 a leakage current portion 406, an active current portion 408, an RF current portion 410, a saved current portion 412 and a saved current portion 414. Y-axis 402 measures current consumption, whereas x-axis 404 measures time. A full burst length is indicated by double arrow 416 and is equal in duration to that of the full burst length as indicated by double arrow 224 of FIG. 2.

Data block 300 is but one block of a series of blocks that make up a communication signal. When a base station is on, but is not transmitting signals, it is consuming a relatively low amount of power. This low amount of power is associated with leakage current portion 406.

Before the base station can transmit a data block, it must power up, which corresponds to the current consumption shown by active current portion 408. The current consumption corresponding to the transmission of data block 300 is RF current portion 410. Right before data block 300 is transmitted and right after data block 300 is transmitted, the amount of current consumption is reduced as shown by saved portions 412 and 414, respectively.

By comparing FIG. 4 to FIG. 2, the base station transmitting power is reduced as the higher power period is reduced. For the mobile station, the receiving period is shortened and therefore its power consumption is also reduced.

In accordance with embodiments of the invention, a data block may be generated in one of four schemes. In a first scheme, the data block is generated to have a conventional block size of 148 bits (or symbols) with the TS portion being centrally located. This first scheme may be used for two users. In second through fourth schemes, the TS portion is again centrally located. The second through fourth schemes are considered to coincide with an “optimized” data block, as the data block is generated to have a smaller block size than the conventional block size. In example embodiments of the second through fourth schemes, the block size is 92 bits (or symbols). The second through fourth schemes may be used for a single user.

In the second scheme, the block is centrally located. In the third scheme, the block is time-shifted to the right. In the fourth scheme, the block is time-shifted to the left.

A base station may need to inform a mobile station as to what kind block will next be sent to the mobile station. In essence, whether the next block is an optimized time-slot or full original block. Returning to FIG. 3, signaling time slot portion 306 and signaling time slot portion 310 are used for such an indication. In example embodiments, signaling time slot portion 306 is a single bit, whereas signaling time slot portion 310 is a single bit. Considered together, the two bits of signaling time slot portion 306 and signaling time slot portion 310 will indicate to a mobile station as to whether the next received block will be in one of four states:

| | |
|---|---|
| 00 | a normal full data block; |
| 11 | an optimized data block; |
| 01 | an optimized data block shifted to the right; or |
| 10 | an optimized data block shifted to the left. |

With this indication, a mobile station will be able to correctly decode a received block.

In accordance with other embodiments, a classmark information bit may be signaled. The classmark information bit may be used to indicate whether optimized data block are supported. For example, a “0” classmark information bit may indicate that optimized data block is not supported, whereas a “1” classmark information bit may indicate that optimized data block is supported.

In VAMOS, the position of the conventional TS portion can be found in 3GPP TS 45.002. In accordance with embodiment of the invention, for the position of the TS portion being in the middle, the only change for new centrally located TS portion may be the duration of the data block. The duration for a normal block, with the TS portion being centrally located and for use with two users, is 147 (148−1=147) bits for GMSK and 147 symbols for 8PSK according to TS 45.005 Annex B. The duration for optimized data block, the duration is reduced from 147 (148−1=147) bits for GMSK and 147 symbols for 8PSK to 91 (92−1=91) bits for GMSK and 91 symbols for 8PSK.

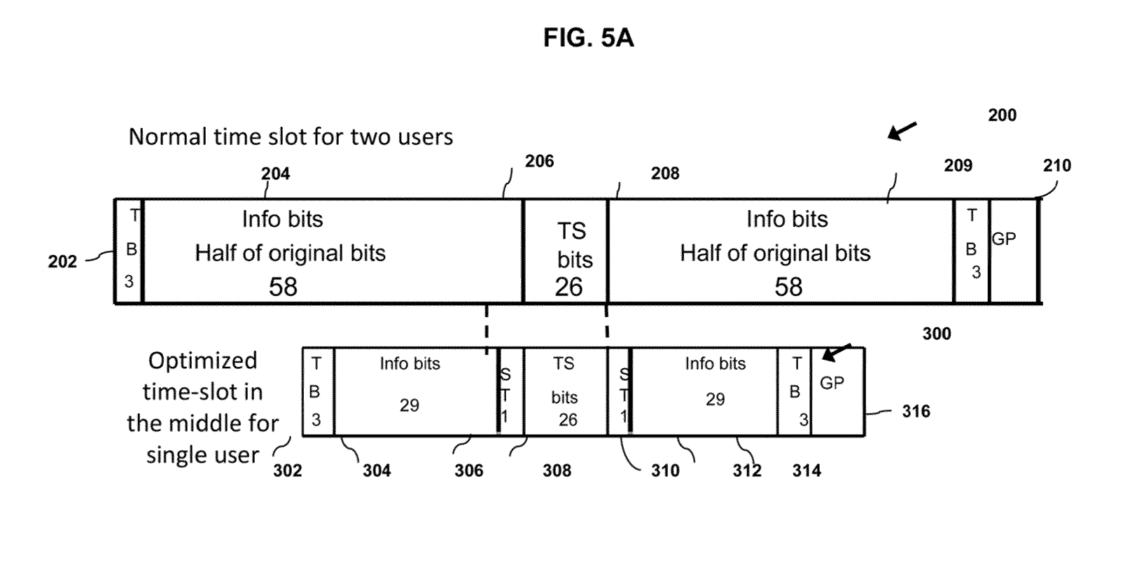

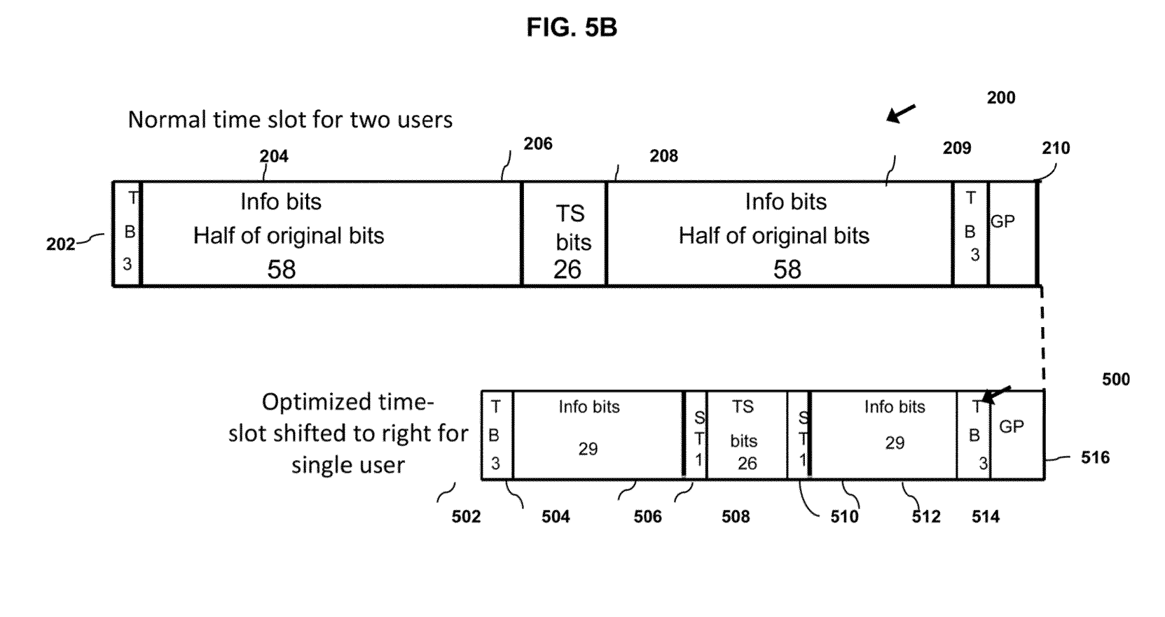

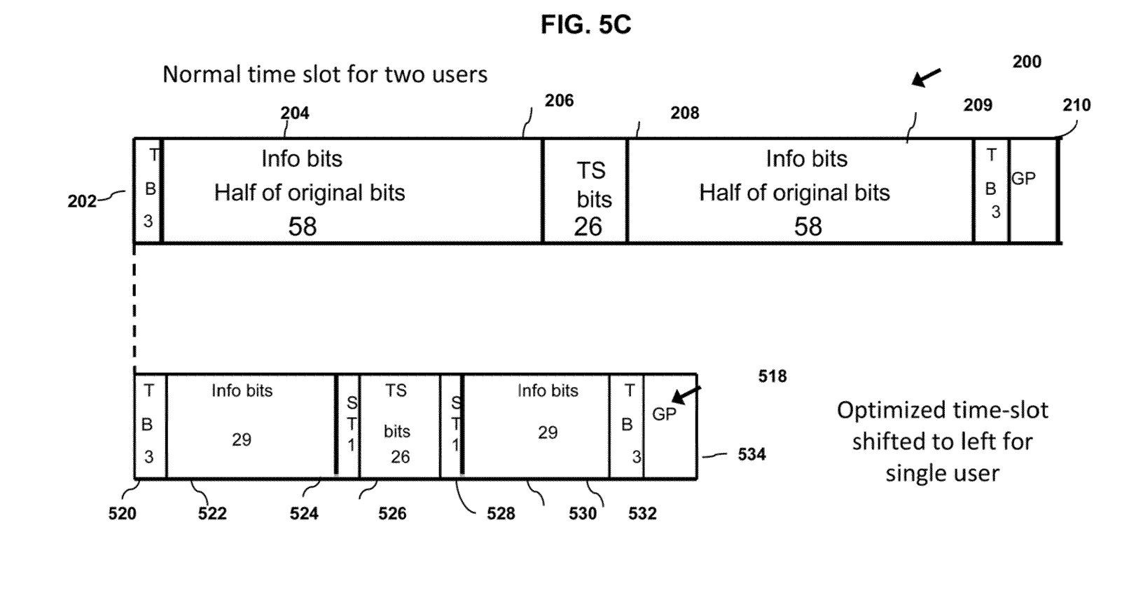

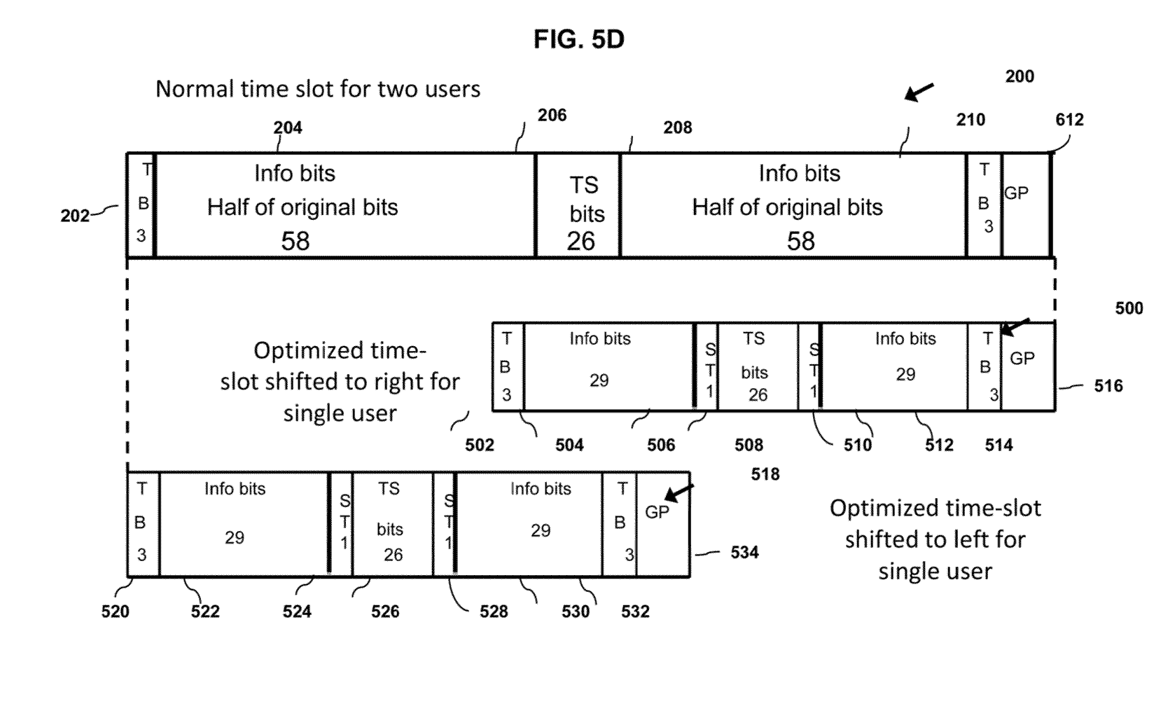

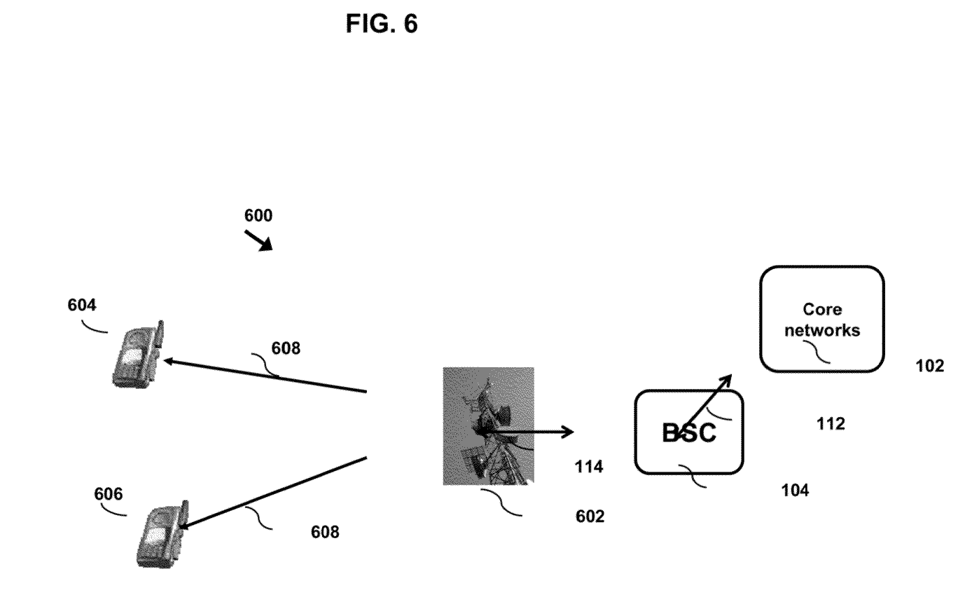

For the optimized data block that is shifted to the left, the TS portion will be shifted to the left. However, the TS portion is still in the middle of the optimized data block, which is shifted to the left. For the optimized data block shifted to the right, the new position of the TS portion will be shifted to the right. However, the TS portion is still in the middle of the optimized data block that is shifted to the right. The sizes and positions of these example data blocks will now be described in greater detail with reference to FIGS. 5A-6.

FIG. 5A illustrates a current data block 200 and optimized data block 300 in accordance with embodiments of the invention.

FIG. 6 illustrates an example VAMOS technology communication system 600, in accordance with embodiments of the invention.

As shown in the figure, system 600 includes, a base station 602, BSC (Base Station Controller) 104 and core networks 102, a mobile station 604 and a mobile station 606.

Base station 602 is also arranged to receive a communication signal 114 from BSC 106. Mobile station 604 is arranged to receive a communication signal 608 from base station 602. Mobile station 606 is arranged to receive communication signal 608 from base station 602.

With reference to FIG. 5A, data block 200 is much larger than data block 300. In this example, data block 200 is an example of a full data block that may be generated by base station 602 for use by mobile station 604 and mobile station 606. On the contrary, optimized data block 300 is an example of an optimized data block that may be generated by base station 602 for use by a single user. For purposes of discussion, let the single user case be mobile station 604.

Current VAMOS burst payload portion 204 and payload portion 208 are each much larger than payload portion 304 and payload portion 312. The larger size is provided to support data for each of mobile station 604 and mobile station 606 in VAMOS.

As indicated above, for example with reference to FIGS. 1-2, when one of two users using VAMOS is in a silent mode, there is no data to be transmitted in the payload of a data block. Nevertheless, if a data block is transmitted, power will be wasted by the base station.

To avoid this waste of power consumption, optimized data block 300 may be used in situations where mobile station 606 is in a silent mode. In such a case, the payload may be reduced, as there is no data that needs to be transmitted for mobile station 606 in the silent mode. For this reason, in an example embodiment, optimized data block 300 is reduced from 148 bits (of symbols) to 92 bits (or symbols).

In an example embodiment, in a first state, the two bits of signaling time slot portion 306 and signaling time slot portion 310 being “00” may be used to indicate to a mobile station that the currently received block is the last optimized data block and that a conventional data block will be the next received block. In other words, if mobile station 604 is currently processing a data block similar to data block 300, and signaling time slot portion 306 and signaling time slot portion 310 are “00,” then mobile station 604 will be prepared to receive the next data block as a data block similar to data block 500. This may be used when mobile station 606 transitions from a silent mode to an active mode.

In an example embodiment, in a second state, the two bits of signaling time slot portion 306 and signaling time slot portion 310 being “11” may be used to indicate to a mobile station that an optimized data block will be received next when one user transitions from an active mode to a silent mode. In other words, if mobile station 604 is currently processing a data block similar to data block 500, and signaling time slot portion 306 and signaling time slot portion 310 are “11,” then mobile station 604 will be prepared to receive the next data block as a data block similar to data block 300. This may be used when mobile station 606 transitions from an active mode to a silent mode. In this situation, the optimized data block is centrally aligned with a full data block.

In the example described with reference to FIG. 5A, TS portion 308 of optimized data block 300 is aligned with TS portion 506 of full data block 500. In other embodiments, the TS portion of the optimized data block may be time-shifted to the left or right. This will be described with reference to FIGS. 5B-C.

FIG. 5B illustrates current data block 200 and an optimized data block 500 in accordance with embodiments of the invention.

As shown in the figure, optimized data block 500 is shifted to the right of current data block 200. Optimized data block 500 includes a TB portion 502, a payload portion 504, a signaling time slot portion 506, a TS portion 508, a signaling time slot portion 510, a payload portion 512, a TB portion 514 and a GP 516. TB portion 502 is the start of optimized data block 500. Payload portion 504 follows TB portion 502 and is followed by signaling time slot portion 506. TS portion 508 follows signaling time slot portion 506 and is followed by signaling time slot portion 510. Payload portion 512 follows signaling time slot portion 510 and is followed by TB portion 514. GP 516 follows TB portion 514.

In an example embodiment, in a third state, the two bits of signaling time slot portion 506 and signaling time slot portion 510 being “01” may be used to indicate to a mobile station that the next data block to be received will be an optimized data block when one user transitions from an active mode to a silent mode. However, in this situation, TS portion 522 of optimized data block 514 starts from the right of TS portion 206 of current data block 200.

FIG. 5C illustrates a current data block 200 and an optimized data block 518 in accordance with embodiments of the invention.

As shown in the figure, optimized data block 518 is shifted to the left of current data block 200. Optimized data block 518 includes a TB portion 520, a payload portion 522, a signaling time slot portion 524, a TS portion 526, a signaling time slot portion 528, a payload portion 530, a TB portion 532 and a GP 534. TB portion 520 is the start of optimized data block 518. Payload portion 522 follows TB portion 520 and is followed by signaling time slot portion 524. TS portion 526 follows signaling time slot portion 524 and is followed by signaling time slot portion 528. Payload portion 530 follows signaling time slot portion 528 and is followed by TB portion 532. GP 534 follows TB portion 532.

In an example embodiment, in a fourth state, the two bits of signaling time slot portion 524 and signaling time slot portion 528 being “10” may be used to indicate to a mobile station that the next data block to be received will be an optimized data block when one user transitions from an active mode to a silent mode. However, in this situation, TS portion 526 of optimized data block 518 starts from the left of TS portion 206 of current data block 200.

With the help of the shifted left and right time slot formats, one normal time slot period can accommodate two reduced time slots. For example, as shown in FIG. 5D, the time period needed to accommodate full data block 200 may accommodate optimized data block 500 and optimized data block 518. Further, TS portion 526 of optimized data block 518 does not overlap with TS portion 508 of optimized data block 500. The overlapped bits are only 36 bits compared the total length of 92 bits.

It is this feature of the optimized and shifted time slots that allow two time-slots to transmit at same time, thereby doubling the number of MS supported per time slot period as showed in FIG. 5D.

According to an embodiment of the invention, small data packets are generally expected when MTC communication is employed. If the conventional VAMOS timeslot structure is used to generate packets for transmission from a base station to for receipt by two mobile stations, some of the information bits may be padded with bits that do not contain information. In such a scenario, the receiving mobile stations may waste power receiving and decoding these bits. However, if the reduced time length timeslot in accordance with example embodiments is used, the optimized time-slot length will be more adequate to transmit small data packets. This will save power of when MTC devices receive and decode such packets and will also reduce power consumption at the base station when generating the packets. In order to accommodate more MTC devices, the shifted left and right reduced time slots are also provided. With the shifted left and right reduced time slots, the number of time slots is doubled.

Structures for encoders and decoders in example embodiments will now be described.

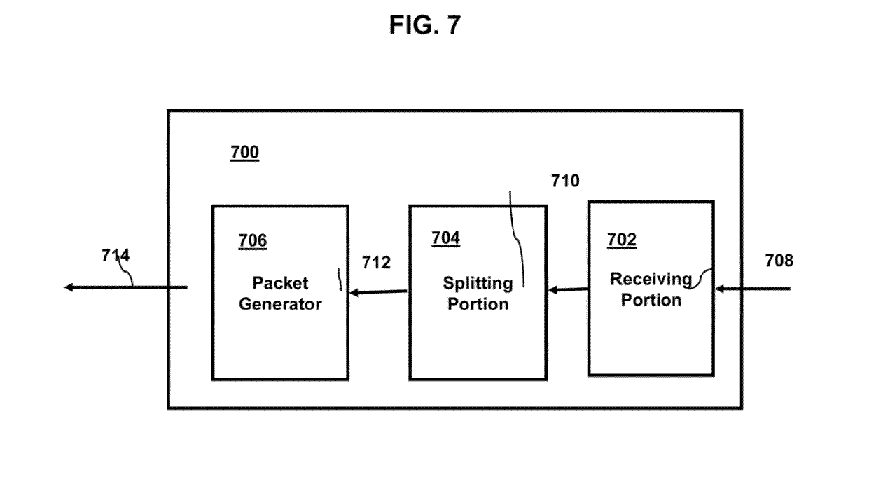

FIG. 7 illustrates an example encoder 700 in accordance with embodiments of the invention. Encoder 700 may be used in base station 602 to encode data blocks for transmission to mobile stations 604 and 606.

As shown in FIG. 7, encoder 700 includes a receiving portion 702, a splitting portion 704 and a packet generator 706. In this example, receiving portion 702, splitting portion 704 and packet generator 706 are distinct elements. However, in some embodiments, at least two of receiving portion 702, splitting portion 704 and packet generator 706 may be combined as a unitary element. In other embodiments, at least one of receiving portion 702, splitting portion 704 and packet generator 706 may be implemented as a computer having stored therein tangible, non-transitory, computer-readable media for carrying or having computer-executable instructions or data structures stored thereon. Such tangible, non-transitory, computer-readable media can be any available media that can be accessed by a general purpose or special purpose computer. Non-limiting examples of tangible, non-transitory, computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. Combinations of the above should also be included within the scope of tangible, non-transitory, computer-readable media.

Receiving portion 702 is arranged to receive channel-encoded bits as an encoded speech block 708 and output an encoded speech block 710. Splitting portion 704 is arranged to receive encoded speech block 710 and output split blocks 712. Packet generator 706 is arranged to receive split blocks 712 and output a data block 714.

Data block 714 may correspond to any one of full data block 200, optimized data block 300, optimized data block 500 and optimized data block 518.

When data block 714 corresponds to full data block 200, the number of channel-encoded bits in encoded speech block 708 is equal to the number of bits in split blocks 712. Returning to FIG. 5A, split blocks 712 will correspond to payload portion 204 and payload portion 208.

When data block 714 corresponds to an optimized data block, such as optimized data block 300, the number of channel-encoded bits in encoded speech block 708 is still equal to the number of bits in split blocks 712. Returning to FIG. 5A, split blocks 712 in this situation will correspond to payload portion 304 and payload portion 312.

Once transmitted, both of mobile stations 604 and 606 will receive the data blocks, which must then be decoded.

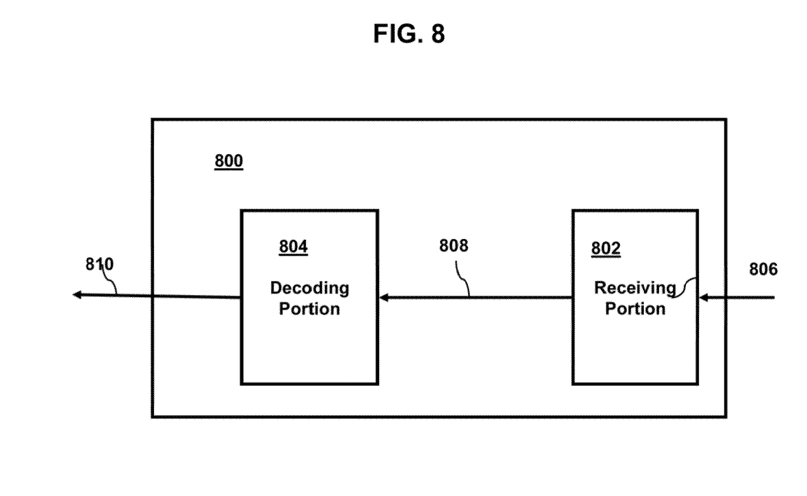

FIG. 8 illustrates an example decoder 800 in accordance with embodiments of the invention. Decoder 800 may be included in mobile station 604 (with a similar decoder being included in mobile station 606).

As shown in FIG. 8, decoder 800 includes a receiving portion 802 and a decoding portion 804. In this example, receiving portion 802 and decoding portion 804 are distinct elements. However, in some embodiments, receiving portion 802 and decoding portion 804 may be combined as a unitary element. In other embodiments, at least one of receiving portion 802 and decoding portion 804 may be implemented as a computer having stored therein tangible, non-transitory, computer-readable media for carrying or having computer-executable instructions or data structures stored thereon.

Receiving portion 802 is arranged to receive an encoded data block 806 and output an encoded data block 808. Decoding portion 804 is arranged to receive encoded data block 808 and output a data block 810.

Encoded data block 810 may correspond to any one of full data block 500, optimized data block 300, optimized data block 500 and optimized data block 518.

Data block 810 includes channel-encoded bits as an encoded speech block and will correspond to encoded speech block 708. Data block 810 will eventually be further decoded into the original speech data.

Embodiments of the invention allow power reduction in both the transmitter and receiver, when there is no other user sharing the timeslot. Exploitation of the modulation and coding scheme introduced by VAMOS allows the information rate to be maintained, without reducing the cell coverage area. The TS portion is centrally located within a data block, allowing for enhanced channel estimation as compared to the conventional VAMOS data block.

Embodiments of the invention include generation of a classmark bit, which allows recognition of the capability of a mobile station to decode an optimized data block format.

Embodiments of the invention double the number of data blocks within a time frame of a full data block for MTC devices. Three different starting times may be used for the optimized data block (left, middle and right). This could be extended further under favorable channel conditions and for suitably short message sizes.

The foregoing description of various embodiments of the invention have been presented for purposes of illustration and description. It is not intended to be exhaustive or to limit the invention to the precise forms disclosed, and obviously many modifications and variations are possible in light of the above teaching.

1. An encoder comprising:
a receiving portion operable to receive channel-encoded data bits;
a splitting portion operable to generate, from the received channel-encoded data bits, a first portion of data bits and a second portion of data bits; and
a block generator operable to generate an output block for a single user in an output block over adaptive multi-user channels on one slot format, the output block including a first tail bits portion, the first portion of data bits, a training sequence portion, the second portion of data bits, a second tail bits portion and a guard period portion,
wherein the training sequence portion is arranged between the first portion of data bits and the second portion of data bits.

2. The encoder of claim 1, wherein the sum of a total number of bits within the first portion of data bits and a total number of bits within the second portion of data bits is equal to a total number of received channel-encoded data bits.

3. The encoder of claim 1, wherein said block generator is operable to generate the output block to further include a signaling time slot format portion.

4. The encoder of claim 3, wherein said block generator is operable to generate the output block to further include a second signaling time slot format portion.

5. The encoder of claim 4, wherein the signaling time slot format portion and the second signaling time slot format portion are arranged between the first portion of data bits and the second portion of data bits.

6. The encoder of claim 5, wherein the training sequence portion is arranged between the signaling time slot format portion and the second signaling time slot format portion.

7. The encoder of claim 5,
wherein the signaling time slot format portion comprises a first binary bit,
wherein the second signaling time slot format portion comprises a second binary bit,
wherein the combination of the first binary bit and the second binary bit is operable to be in one of four states, and
wherein each of the four states is operable to indicate that the output block is one of four types of output blocks, respectively.

8. The encoder of claim 7, wherein when the combination of the first binary bit and the second binary bit is in a first state, the combination indicates that the output block is the last optimized block for single user and next output block will be the normal output block for two users.

9. The encoder of claim 7, wherein when the combination of the first binary bit and the second binary bit is in a second state, the combination indicates that the next output block is an optimized block for a single user and further indicates that the output block aligns to the middle of the normal time slot.

10. The encoder of claim 7, wherein when the combination of the first binary bit and the second binary bit is in a third state, the combination indicates that the next output block is an optimized block for a single user and further indicates that the output block aligns to the left of the normal time slot.

11. The encoder of claim 7, wherein when the combination of the first binary bit and the second binary bit is in a fourth state, the combination indicates that the next output block is an optimized block for a single user and further indicates that the output block aligns to the right of the normal time slot.

12. The encoder of claim 11,
wherein said receiving portion is further operable to receive second channel-encoded data bits,
wherein said splitting portion is further operable to generate, from the second received channel-encoded data bits, a first portion of second data bits and a second portion of second data bits,
wherein said block generator is further operable to generate a second output block for a second single user in the output block over adaptive multi-user channels on one slot format, the second output block including a third tail bits portion, the first portion of second data bits, a second training sequence portion, the second portion of second data bits, a fourth tail bits portion and a second guard period portion,
wherein the second training sequence portion is arranged between the first portion of second data bits and the second portion of second data bits, and
wherein the second output block can be transmitted so as to be partially overlapped with the first output block.

13. The encoder of claim 1, wherein said block generator is further operable to generate the output block for machine type communications.

14. A decoder comprising:
a receiving portion operable to receive an encoded block for a single user in an encoded block over adaptive multi-user channels on one slot format, the encoded block including a first tail bits portion, a first portion of data bits, a training sequence portion, a second portion of data bits, a second tail bits portion and a guard period portion; and
a decoding portion operable to generate an output data block based on the first portion of data bits and the second portion of data bits.

15. The decoder of claim 14, wherein said decoding portion is operable to generate the output data block by splicing the first portion of data bits with the second portion of data bits.

16. The decoder of claim 14, wherein said receiving portion is operable to receive the encoded block further including a signaling time slot format portion.

17. The decoder of claim 16, wherein said receiving portion is operable to receive the encoded block further including a second signaling time slot format portion.

18. The decoder of claim 17, wherein the signaling time slot format portion and the second signaling time slot format portion are arranged between the first portion of data bits and the second portion of data bits.

19. The decoder of claim 18,
wherein the signaling time slot format portion comprises a first binary bit,
wherein the second signaling time slot format portion comprises a second binary bit,
wherein the combination of the first binary bit and the second binary bit is operable to be in one of four states, and
wherein each of the four states is operable to indicate that the encoded block is one of four types of encoded blocks, respectively.

20. The decoder of claim 19, wherein when the combination of the first binary bit and the second binary bit is in a first state, the combination indicates the next received block will be the normal block for two users.

21. The decoder of claim 19, wherein when the combination of the first binary bit and the second binary bit is in a second state, the combination indicates that the next received block will be the optimized output block for a single user and received block aligns to the middle of the normal time slot.

22. The decoder of claim 19, wherein when the combination of the first binary bit and the second binary bit is in a third state, the combination indicates that the next received block is an optimized block for a single user and further indicates that the received block aligns to the left of the normal time slot.

23. The decoder of claim 19, wherein when the combination of the first binary bit and the second binary bit is in a fourth state, the combination indicates that the next received block is an optimized block for a single user and further indicates that the received block aligns to the right of the normal time slot.

24. The decoder of claim 14, wherein said receiving portion is further operable to receive an encoded block in one of an encoded block voice services over adaptive multi-user channels on one slot format and an encoded block for machine type communications.

25. A method of encoding comprising:
receiving, via a receiving portion, channel-encoded data bits;
generating, via a splitting portion and from the received channel-encoded data bits, a first portion of data bits and a second portion of data bits; and
generating, via a block generator, an output block in an output block over adaptive multi-user channels on one slot format, the output block including a first tail bits portion, the first portion of data bits, a training sequence portion, the second portion of data bits, a second tail bits portion and a guard period portion,
wherein the training sequence portion is arranged between the first portion of data bits and the second portion of data bits.

26. The method of claim 25, wherein the sum of a total number of bits within the first portion of data bits and a total number of bits within the second portion of data bits is equal to a total number of received channel-encoded data bits.

27. The method of claim 25, wherein said generating, via a block generator, an output block including a first tail bits portion, the first portion of data bits, a training sequence portion; the second portion of data bits, a second tail bits portion and a guard period portion comprises generating the output block to further include a signaling time slot format portion.

28. The method of claim 27, wherein said generating the output block to further include a signaling time slot format portion comprises generating the output block to further include a second signaling time slot format portion.

29. The method of claim 28, wherein the signaling time slot format portion and the second signaling time slot format portion are arranged between the first portion of data bits and the second portion of data bits.

30. The method of claim 29, wherein the training sequence portion is arranged between the signaling time slot format portion and the second signaling time slot format portion.

31. The method of claim 29,
wherein the signaling time slot format portion comprises a first binary bit,
wherein the second signaling time slot format portion comprises a second binary bit,
wherein the combination of the first binary bit and the second binary bit is operable to be in one of four states, and
wherein each of the four states is operable to indicate that the output block is one of four types of output blocks, respectively.

32. The method of claim 31, wherein when the combination of the first binary bit and the second binary bit is in a first state, the combination indicates that output block is the last optimized block for a single user and the next output block will be the normal output block for two users.

33. The method of claim 31, wherein when the combination of the first binary bit and the second binary bit is in a second state, the combination indicates that the next output block is an optimized block for a single user and further indicates that the output block aligns to the middle of the normal time slot.

34. The method of claim 31, wherein when the combination of the first binary bit and the second binary bit is in a third state, the combination indicates that the next output block is an optimized block for a single user and further indicates that the output block aligns to the left of the normal time slot.

35. The method of claim 31, wherein when the combination of the first binary bit and the second binary bit is in a fourth state, the combination indicates that the next output block is an optimized block for a single user and further indicates that the output block aligns to the right of the normal time slot.

36. The method of claim 31, further comprising:
receiving, via the receiving portion, second channel-encoded data bits;
generating, via the splitting portion and from the second received channel-encoded data bits, a first portion of second data bits and a second portion of second data bits;
generating, via the block generator, a second output block in the output block over adaptive multi-user channels on one slot format, the second output block including a third tail bits portion, the first portion of second data bits, a second training sequence portion, the second portion of second data bits, a fourth tail bits portion and a second guard period portion,
wherein the second training sequence portion is arranged between the first portion of second data bits and the second portion of second data bits, and
wherein said the second output block can be transmitted with partially overlapped with the first output block.

37. The method of claim 25, wherein said generating, via a block generator, an output block comprises generating the output block in one of an output block voice services over adaptive multi-user channels on one slot format and an output block for machine type communications.

38. A method of decoding comprising:
receiving, via a receiving portion, an encoded block for a single user in an encoded block over adaptive multi-user channels on one slot format, the encoded block including a first tail bits portion, a first portion of data bits, a training sequence portion, a second portion of data bits, a second tail bits portion and a guard period portion; and
generating, via a decoding portion, an output data block based on the first portion of data bits and the second portion of data bits.

39. The method of claim 38, wherein said generating, via a decoding portion, an output data block based on the first portion of data bits and the second portion of data bits comprises generating the output data block by splicing the first portion of data bits with the second portion of data bits.

40. The method of claim 38, wherein said receiving, via a receiving portion, an encoded block including a first tail bits portion, a first portion of data bits, a training sequence portion, a second portion of data bits, a second tail bits portion and a guard period portion comprises receiving the encoded block further including a signaling time slot format portion.

41. The method of claim 40, wherein said receiving the encoded block further including a signaling time slot format portion comprises receiving the encoded block further including a second signaling time slot format portion.

42. The method of claim 41, wherein the signaling time slot format portion and the second signaling time slot format portion are arranged between the first portion of data bits and the second portion of data bits.

43. The method of claim 42,
wherein the signaling time slot format portion comprises a first binary bit,
wherein the second signaling time slot format portion comprises a second binary bit,
wherein the combination of the first binary bit and the second binary bit is operable to be in one of four states, and
wherein each of the four states is operable to indicate that the encoded block is one of four types of encoded blocks, respectively.

44. The method of claim 43, wherein when the combination of the first binary bit and the second binary bit is in a first state, the combination indicates the next received block will be the normal block for two users.

45. The method of claim 43, wherein when the combination of the first binary bit and the second binary bit is in a second state, the combination indicates that the next received block will be the optimized output block for a single user and received block aligns to the middle of the normal time slot.

46. The method of claim 43, wherein when the combination of the first binary bit is and the second binary bit is in a third state, the combination indicates that the next received block is an optimized block for a single user and further indicates that the received block aligns to the left of the normal time slot.

47. The method of claim 43, wherein when the combination of the first binary bit is and the second binary bit is in a fourth state, the combination indicates that the next received block is an optimized block for a single user and further indicates that the received block aligns to the right of the normal time slot.

48. The method of claim 38, wherein said receiving, via a receiving portion, an encoded block comprises receiving the encoded block in one of an encoded block voice services over adaptive multi-user channels on one slot format and an encoded block for machine type communications.
